(19) United States
(12) Patent Application Publication
(10) Pub. No.: US 2024/0330816 A1
(43) Pub. Date: Oct. 3, 2024

(54) REAL-TIME RISK ASSESSMENTS

(71) Applicant: NCR Voyix Corporation, Atlanta, GA (US)

(72) Inventors: Shay Marom, Kiryat Tiv’on (IL); Itamar David Laserson, Givat Shmuel (IL)

(21) Appl. No.: 18/129,684

(22) Filed: Mar. 31, 2023

(51) Int. Cl. G06Q 10/0635; G06N 20/00

(52) U.S. Cl. CPC G06Q 10/0635; G06N 20/00

(57) ABSTRACT

Transaction data, customer data, employee data, and security data are obtained for a store. Transactions associated with shrink events are identified and features are derived. The data is labeled and used to train a machine-learning model to produce, as output, scores for the features and combinations of the features, where each score represents a likelihood of shrink for a given feature or a given feature combination. The scores are mapped to a heatmap data structure that includes labels or icons for resources associated with the features and indicia such as colors that are indicative of the scores. The heatmap data structure is overlaid onto a map or a physical layout for the store to show locations of the resources within the store. The labels or icons are user-selectable within the heatmap and the indicia corresponding to a selected combination of icons is adjusted based on the combination's assigned score. Additionally, the heatmap is animated over time intervals corresponding to the operating hours of the store.

### BACKGROUND

According to recent studies, retailers in the U.S. alone lose $47 billion annually to shrink; amounting to about 2% of their annual revenues. About one-third of shrink is associated with shoplifting, which mostly occurs at self-checkout lanes. An additional 40% is employee-related shrink which may be deliberate or non-deliberate due to lack of proper employee training. The remaining shrink can be attributed to administrative errors and perishable items lost to spoilage.

Retails invest billions of dollars in fraud and theft detection technologies, such as artificial intelligence (AI), computer vision, cashier profiling, and anomaly detection. These technologies are important to reducing shrink but are largely focused on detection of shrink instead of prevention of future shrink.

### SUMMARY

In various embodiments, system and methods for providing real-time risk assessments of shrink are presented. A variety of store-maintained data is obtained for transactions, terminals, items, security, customers, and employees. Features are derived from the data and a machine learning model (MLM) is trained on the features to produce scores for a likelihood of shrink on a per resource basis and on a per combination of resources basis. The scores produced by the MLM are consumed by a heatmap interface, which provides a real-time heatmap for shrink during a business day of the store.

The heatmap may overlay color coded resource identifiers within a physical layout of the store. The colors or color gradations of the resources presented within the heatmap are based on the corresponding MLM-provided shrink assessment scores. The heatmap is interactive such that multiple resources are selectable as a combination, and an MLM-provided score for the combination is used to uniquely color the combination within the heatmap. The heatmap also depicts intervals of time for a given business day of the store as a user-selectable animation option such that the predicted risks for the resources and the combinations of resources are visible during any given interval of time during the business day of the store. The current interval of time and the future intervals of time depicted within the heatmap are continuously updated with real-time data being reported by the store's transaction system and security system.

### BRIEF DESCRIPTION OF THE DRAWINGS

FIG. 1 is a diagram of a system for providing real-time risk assessments of shrink, according to an example embodiment.

FIG. 2 is a flow diagram of a method for providing real-time risk assessments of shrink, according to an example embodiment.

FIG. 3 is a flow diagram of another method for providing real-time risk assessments of shrink, according to an example embodiment.

### DETAILED DESCRIPTION

As stated above, shrink is an expensive problem suffered by retailers for a variety of reasons. Many retailers have a variety of technologies in place for detecting shrink-based events when they potentially occur, but few retailers deploy technology that predicts future shrink. Even if a retailer deploys a shrink prediction technology, such technology lacks an ability to pinpoint conditions, events, and locations within a store that are most likely to experience the shrink. That is, any existing shrink prediction technology only provides coarse-grained prediction information and does not provide fine-grained actionable information for the retailer. For example, a retailer may be warned that theft is likely to occur at a given store on a given day, but the retailer is not provided enough information to know that the theft is likely going to happen at a particular cashier-assisted terminal or self-service terminal, which is located within a meat department of a particular retailer's store, late in the afternoon.

As is described in more detail herein and below, retail-time risk assessments of shrink are provided to retailers, which predict a specific condition or a specific set of conditions most likely to be associated with a potential shrink event. This allows retailers to focus on the resources (e.g., customers, employees, terminals, etc.) and in-store departments associated with the conditions in an effort to avoid the shrink.

A machine learning model (MLM) is trained to learn shrink events from input received from video and images associated with past known shrink events. The MLM interoperates the past shrink events to learn the properties and conditions of shrink events on a per store basis. For example, the MLM includes a Random Forest regression model and one or more data-cleaning algorithms that are based on the detection of outliers. Dynamic thresholds are applied to determine the statistical value of a given feature and/or set of features to ensure a well-trained MLM for detecting dimensions or features of shrink (e.g., conditions and properties) for a given store.

The MLM is trained in input dimensions or features associated with shrink events. Example features include 1) Time—the risk of shrink over time, including day of week, time of day, weekend versus weekend, holiday versus regular business day, seasonality, etc.; 2) Basket Content—the risk for shrink by item or product, store departments, item categories, item sub categories, brands, etc. for customer basket items for customers shopping at a given store; 3) Checkout Channel—the risk of shrink based on the checkout method used for a given transaction, such as casher-assisted at a point-of-sale (POS) terminal, self-checkout at a self-service terminal (SST), self-checkout via a mobile application or mobile service, etc.; 4) Cashier—the risk for shrink by specific cashier performing a given checkout; 5) Weather—the risk of shrink based on the current weather and hourly weather predictions provided by an online weather service for a given location of a given store (e.g., whether the weather is sunny, rainy, snowy, etc., the outside temperature as compared to a threshold temperature, and so forth); 6) Loyalty Members—the risk of shrink by specific recurring members of the store or shoppers identified uniquely in other manners; and 7) Method of Payment—the risk of shrink based on the types of payments being used for transactions in the store, such as credit card, bank card, debit card, gift card, check, cash, etc.

Verified shrink events for which shrink was identified are labeled and provided as input to the MLM during training. The expected output from the MLM are scores predicting a likelihood of shrink on a per feature basis and likelihood of shrink based on combinations of the features. A balanced training data set, which includes transaction data and video or image data that includes shrink events and non-shrink events, is used to train and test the F1 score of the MLM. When the F1 score reaches a threshold, the MLM is released to production for providing real-time shrink assessment of shrink for a given store.

The output scores provided by the MLM can be processed in a variety of manners. For example, a graphical user interface (GUI) receives the shrink prediction scores as input from the MLM and uses the scores to render a dynamic and real-time visual heatmap of the store on a user device's display with the features colored based on their corresponding MLM-provided scores. Combinations of the features are selectable from the GUI for a user to visualize the corresponding combination score as a unique color (i.e., unique shrink score) associated with the selected features. It should be appreciated that other indicia can be used in addition or alternatively to color. As another example, the MLM-provided scores are provided to store applications, store systems, and/or store workflows, via an application programming interface (API), as a cloud-based service. The applications, systems, and/or workflows evaluate the scores for purposes of recommending actions that should be taken to mitigate shrink.

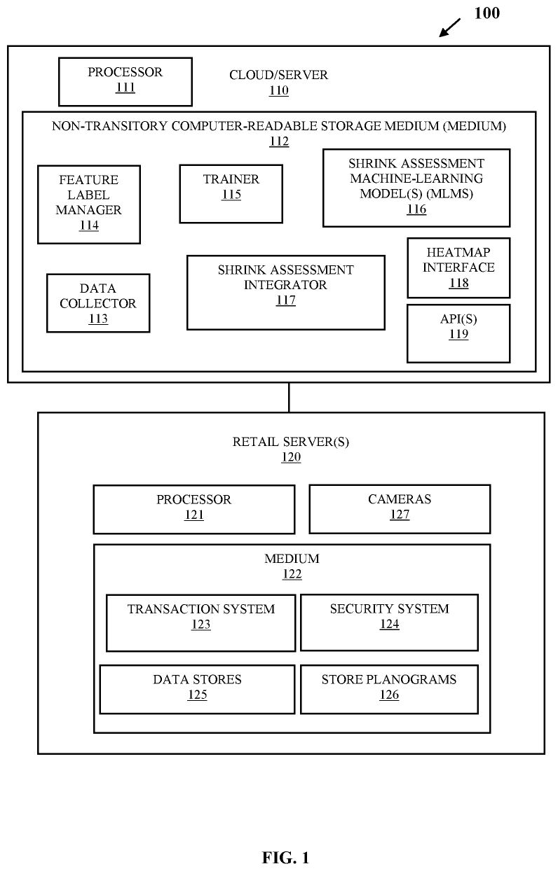

The above-referenced embodiments and other embodiments are now discussed in reference to the Figures, beginning with FIG. 1. FIG. 1 is a diagram of a system 100 for providing real-time risk assessments of shrink, according to an example embodiment. It is to be noted that the components are shown schematically in greatly simplified form, with only those components relevant to understanding of the embodiments being illustrated.

Furthermore, the various components illustrated in FIG. 1 and their arrangement is presented for purposes of illustration only. It is to be noted that other arrangements with more or less components are possible without departing from the teachings of fine-grained shrink risk assessments on a per feature and/or per feature combination basis for a given store.

System 100 includes a cloud 110 or a server 110 (hereinafter just “cloud 110”) and a plurality of enterprise servers 120. Cloud 110 includes a processor 111 and a non-transitory computer-readable storage medium (hereinafter just “medium”) 112, which includes executable instructions for a data collector 113, feature label manager 114, an MLM trainer 115, one or more shrink assessment MLMs 117, a shrink assessment integrator 117, a heatmap interface 118, and one or more integration APIs 119. Processor 111 obtains or is provided the executable instructions from medium 112 causing processor 111 to perform operations discussed herein and below with respect to 113-119.

Each retailer server 120 includes a processor 121 and a medium 122, which includes executable instructions for a transaction system 123, a security system 124, a plurality of data stores 125, and store planograms 126. Processor 121 obtains or is provided the executable instructions from medium 122 causing processor 121 to perform operations discussed herein and below with respect to 123-124. It is to be noted that retailer server 120 can include a variety of other systems, such as an inventory system, a maintenance and support system, a scheduling system, etc. Moreover, access to data stores 125 and planograms 126 can be through APIs or data store interfaces and applications.

Each retail server 120 also include cameras 127, which capture video and/or images of areas situated throughout a given store of a retailer. The images are stored in storage and/or streamed to network-accessible storage locations, which are accessible to the corresponding security system 124 and data collector 113 of cloud 110.

The data stores 125 include a variety of information maintained by the corresponding retailer. For example, a loyalty data store 125 includes records for customers of the retailer, each record includes customer identifying data and contact data, customer transaction history data, customer promotions offered, customer redeemed promotions, customer preferences or profiles, etc. An employee data store includes records per employee of the store, each record includes employee identifying data and contact data, dates and times of previous work days, current scheduled days and times for future work days, terminal identifiers for the terminals operated by the employee on each of previous work days, total number of transactions performed by the employee on each previous work day, total number of price overrides performed on each previous work day, total number of returns performed on each previous work day, total number of transaction item voids performed on each previous work day, etc. A product data store includes item identifiers for products, item classifications, item barcodes, item descriptions, item pricing, etc.

A retailer's transaction system 123 includes transaction data for transactions of the retailer, each transaction includes a record with a store identifier for the retailer's store that performed the transaction, a transaction type to indicate whether the transaction was performed online or in the store, an indication as to whether the transaction was a return or whether it was a purchase transaction, terminal identifier for the terminal that performed the transaction when the transaction was performed in store, customer identifier for the customer of the transaction, cashier identifier for a cashier when the customer was assisted with checkout, calendar date of the transaction, time of the transaction, item codes for items purchased in the transaction, item prices, item categories, item discounts, redeemed promotions, etc. The transaction system 123 also includes sales and loss information per store of the retailer such as total sales within a given period of time, the period's sales overall, the period's sales by item, the period's sales by item category, period's sales by store department, period's shrink per item, period's shrink per item category, period's shrink per store department, etc.

A retailer's store planograms 126 includes a map of a given store for the retailer along with labels that identify departments, ingress and egress points, shelves, and displays. Each store's planogram 126 also includes item codes for the physical placement and location of each item or item category within the store on shelves, on displays, and in departments of the corresponding store.

A retailer's security system 124 maintains a plurality of computer-vision metrics for analysis of video or images captured by a store's cameras 127. Some of these metrics are related to shrink events for which theft was identified or vision-based actions that were flagged as being potential theft. The security system 124 includes a variety of security-based applications some of which are based on computer vision analysis, some of which are based on transaction data for a given transaction obtained from the corresponding transaction system 123, and/or some of which are based on a combination of computer vision analysis and transaction data.

Security applications of system 124 also process a variety of algorithms that analyze any given video along with customer data and employee data from the data stores 125 and transaction data from system 123 to provide scores or predictions with respect to potential cashier and/or customer theft based on a variety of factors such as the basket of items, the identity of the cashier, and the identity of the customer when known. In an embodiment, the security applications use one or more additional MLMs to provide the risk scores for a given transaction. The risk scores are retained in security records by transaction, by cashier, and by customer for each store and retained as metrics. Furthermore, each security record also includes a link to the corresponding video associated with any given transaction captured by the store's cameras 127.

In an embodiment, the security system 124 is independent of the retail server 120 and is provided as a service by cloud 110 or by a third-party server via an API to retailer server 120. In an embodiment, security applications utilized by the security system 124 are independent of retail server 120 and provide vision-based analysis of video captured by cameras 127 back to security system 124 on retail server 120.

Initially, data collector 113 uses one or more APIs 119 to obtain input data, which is used to train MLM 116 on information associated with a given store of a retailer's transaction system 123, security system 124, data stores 125, and planogram 126. A training period of time is established; for example, 6 months to a year's worth of historical input data.

Feature label manager 114 correlates the input data based on a given transaction at the store. For example, data obtained from the transaction system 123, the security system 124, the data stores 125 are assembled or merged with one another to define a transaction data set of input data that is associated with a single transaction processed by transaction system 123. The calendar date and time is obtained for each transaction data set and used to obtain weather data from a browser and web-based weather service for a known store location of the store on the corresponding date and time of day. The weather data is labeled and inserted into each transaction data set. The calendar data is then compared against a known holiday schedule to identify whether a given transaction occurred on a holiday. When a holiday is detected, feature label manager 114 labels and inserts a holiday identifier for the corresponding holiday into the transaction data set for the transaction. Each transaction data set is them analyzed by feature label manager to label the calendar date, time of day, item identifiers for the basket of items purchased in the transaction, cashier identifier for any cashier that performed the transaction, customer identifier for the customer, an indication as to whether the customer is or is not a loyalty member, the terminal type indicating whether the terminal is a POS terminal or an SST for the transaction, and the type of payment used.

Any transaction data sets that include one or more shrink events as obtained from the security logs of the security system 124 are labeled within the training data sets. Shrink-even labeled transaction data sets are the expected output which is expected from the MLM 116 following training after receiving the other labeled input features of a given transaction data set from the trainer 115.

The training data set, which includes each of the labeled transaction sets, is passed by feature label manager 114 to trainer 115. The training data set is broken into two portions. A first portion is provided by trainer 115 as input to the MLM 116 for training during a training session and a second portion is provided by the trainer 115 as input to the MLM 116 for testing the f1 score after training. Once the f1 score is at or above a threshold value, trainer 115 releases the MLM 116 for production and notifies the shrink assessment integrator 117.

In an embodiment, any security application scores produced to provide a likelihood of shrink with respect to a given basket of items, a cashier, or a customer is retained and labeled by feature label manager 114 within the training data set. These scores may be produced through other MLMs and/or other heuristic and statistical-based algorithms and leveraged as additional features fed to the MLM 116 by trainer 115 during a training session for the MLM 116.

Data collector 113 obtains real-time and live transaction data and security log data along with the corresponding matching customer data and matching employee data from transaction system 123, security system 124, and data stores 125 once MLM 116 is released in production for a given store of a retailer. The data is obtained by feature label manager 114, merged into live transaction data sets, labeled, and passed to MLM 116 as input.

MLM 116 produces as output scores for each of the features and for combinations of the features. Each score representing a likelihood or probability from 0 to 1 that a given feature or a given combination of features is going to result in shrink within the store.

In an embodiment, the MLM 116 produces sets of scores for a given business day in predefined intervals of time. For example, for a given business day in which a store opens at 8:00 am and closes at 10:00 pm, the MLM 116 is provided a configurable interval of time's worth of data that includes a current business day's worth of data for the store. The MLM 116 provides as output scores for the features and the combination of features at preconfigured intervals of time, such as for each half hour or each hour of operation of the store beginning at 8:00 am and ending at 10:00 pm. Each interval maps to a corresponding portion of the business day and each interval include its own set of scores for the features and combination of features. At each current interval of time, updated sets of scores for the remaining business hours of the store are provided by the MLM 116. So, the MLM provides a time series for a business day at predetermined intervals of time and continuously updates the further time intervals for the business day based on current data being received from the store.

In an embodiment, heatmap interface 118 is configured to use a planogram 126 for a given store as a template or as a background image over which icons and labels are overlaid to represent the resources of the store. The resources are identified via identifiers maintained by the store in the transaction system 123, security system 124, data stores 125, and planogram 126. For example, resources are mapped to icons or graphic images for shelves, terminals, store items, aisles, displays, departments, ingress and egress points, customers, cashiers, etc. The planogram 126 details the locations of resources relative to one another and a layout of the resources within the store. Heatmap interface 118 receives the features and the combination of features scores produced by the MLM 116 and assigns a unique color based on the scores to the icons or the graphical images and superimposes the icons/images onto the background image of the store's layout provided by the planogram 126. The heatmap interface 118 also animates the overlaid and colored resource icons/images by time intervals for the business hours of the store in a given day. For example, assuming a set of scores is provided for every 30 minutes during which the store is open, a timeline can be presented within a user interface presented to a user which when moved forward projects a future time during the business day and depicts the corresponding resources with their colors based on their resource scores at that time during the business day.

A store manager can access the heatmap interface 118 via a user device and receive a snapshot visualization at any point during the business day for risk assessment of shrink through the colored resources; the color gradations of the resources map to MLM predicted scores.

Heatmap interface 118 also allows the store manager to interact with the icons or images representing the resources for purposes of selecting multiple resources within a given area of the store during a given interval of time for the business day. In response to a selection of a combination of resources, the heatmap interface adjust the score-based colors of the combination based on the underlying combination score predicted by the MLM 116.

For example, baskets with items associated with a “meat category” (e.g., item category is meat) are illustrated in the heatmap interface 118 with a higher shrink risk score or darker color red for SSTs during late hours of the business day. A specific cashier has a high risk for undeliberate shrink, which is illustrated in darker red within the heatmap interface, in large baskets that contain many products from the produce department. A specific new cashier in the store has a shrink high risk due to non-deliberate actions of unscanned items during rush hours of the store, which may show a correlation that the barcodes with embedded weights of certain items are difficult to scan properly. The meat department suffers from relative high-risk scores at SSTs during cold days outside of the store, which may show a correlation to customers putting items in jackets being worn. A transaction of a specific loyalty member has a higher risk, which could indicate sweethearting with a cashier at the store. Cash transactions show a higher-risk score than payments with other payment methods during rush hours of the store.

In an embodiment, the feature and combination of features scores are integrated into existing workflows associated with a retailer's transaction system 123 and security system 124. Integrator 117 uses APIs 119 to report the scores to applications within the existing workflows. For example, when a given department is assigned a risk score above a threshold a notification application within the transaction system 123 sends an alert to a store manager's device instructing the manager to visit that department and observe the activity during the high-risk period of time. Another application may be notified to suggest that the manager train cashiers on how to scan heavy meat packaged items, strengthen security within certain departments of the store, generate business rules to trigger security alerts on high-risk items and shoppers. The reported feature and combination of features scores can also be used in store applications and workflows to reduce security and resource friction in areas receiving low shrink risk scores so that the resources and security can be more properly allocated and focused on higher risk areas of the store.

One now appreciates how fine-grained resource-based shrink assessments for a given business day of a store is provided and mapped graphically to a layout of the store within a heatmap interface 118. The heatmap interface 118 is interactive and permits combinations of resources to be selected and grouped together for purposes of visualizing the risk of a resource combination rather than the risks of the resources individually.

The heatmap interface 118 is continuously updated with real-time store data provided by retailer systems 123 and 124 for each interval during the business day. The MLM 116 is trained on relevant shrink correlated dimensions for resources of the store to provide predictive shrink risk assessment scores for not only each of the resource but also combinations of the resources. The heatmap interface 118 allows store managers to obtain a real-time and predictive shrink risk assessment through visualization of the store layout and the store's resources within the layout. The heatmap interface 118 animates over time of a given business day the visualization so that store managers can prepare for upcoming high-risk times during the business day at specific locations within their store.

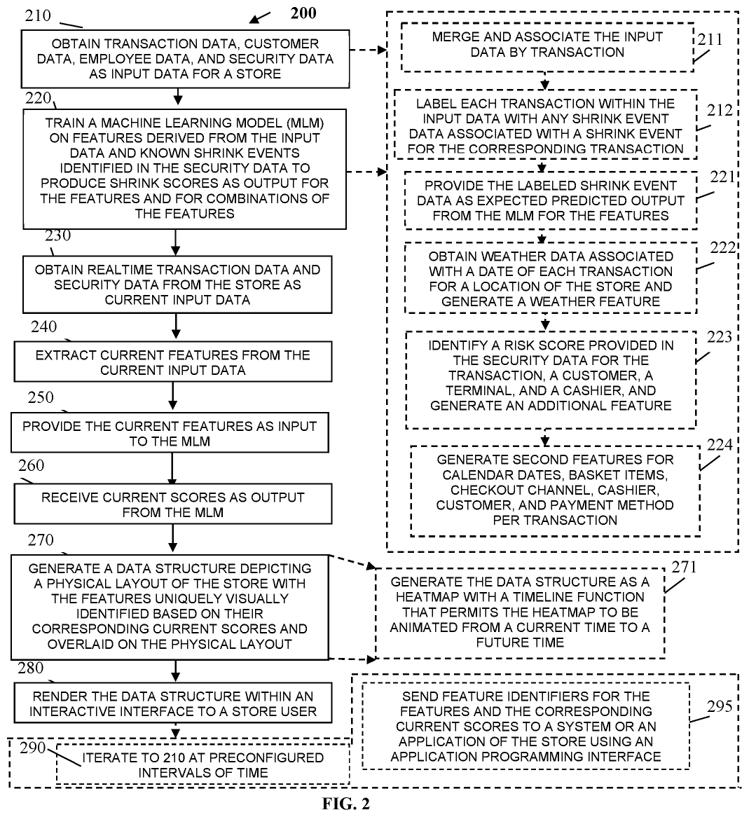

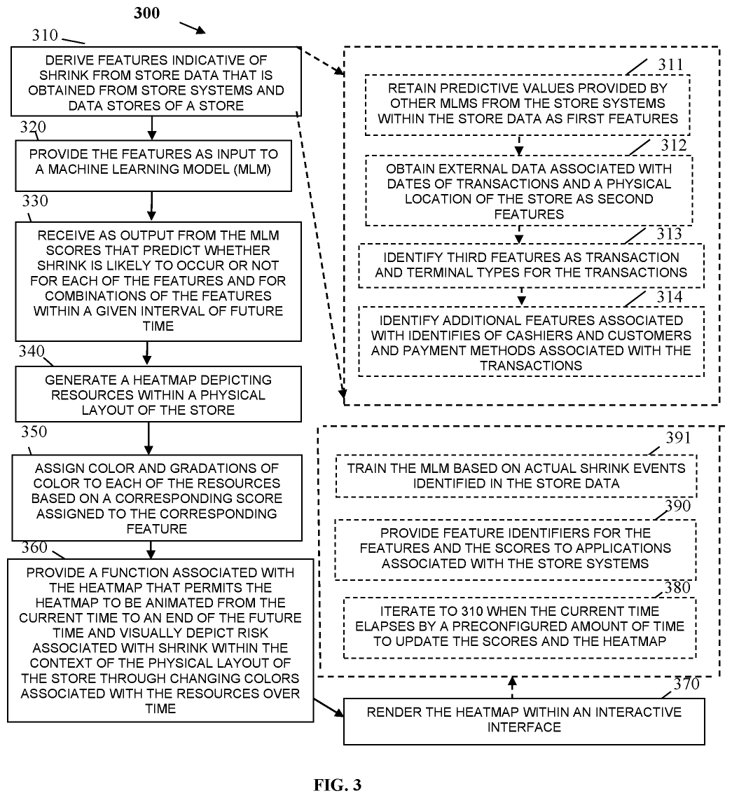

The above-discussed embodiments and other embodiments are now discussed with reference to FIGS. 2-3. FIG. 2 is a flow diagram of a method 200 for providing real-time risk assessments of shrink, according to an example embodiment. The software module(s) that implements the method 200 is referred to as a “shrink store context predictor.” The shrink store context predictor is implemented as executable instructions programmed and residing within memory and/or a non-transitory computer-readable (processor-readable) storage medium and executed by one or more processors of one or more devices. The processor(s) of the device(s) that executes the shrink store context predictor are specifically configured and programmed to process the shrink store context predictor. The shrink store context predictor has access to one or more network connections during its processing. The connections can be wired, wireless, or a combination of wired and wireless.

In an embodiment, the device that executes shrink store context predictor is cloud 110. In an embodiment, the device that executes shrink store context predictor is server 110. In an embodiment, the device that executes shrink store context predictor is retail server 120. In an embodiment, the shrink store context predictor is all of, or some combination of 113, 114, 115, 116, 117, 118, and/or 119. In an embodiment, the shrink store context predictor is provided to a retail server 120 and/or a user-operated device as a SaaS integrated via API calls from applications executed on the retail server 120 or the user-operated device, wherein the applications are associated with transaction system 123 and/or security system 124.

At 210, the shrink store context predictor obtains transaction data, customer data, employee data, and security data as input data for a store. For example, the data is acquired via API 119 from the store's transaction system 123, the store's security system 124, and the store's data stores 125.

In an embodiment, at 211, the shrink store context predictor merges and associated the input data by transaction. That is, each set of data having a same transaction identifier for a given transaction is associated and merged together as a transaction record or transaction data set within the input data.

In an embodiment of 211 and at 212, the shrink store context predictor labels each transaction within the input data with any shrink event data associated with a shrink event for the corresponding transaction. Not all transactions will be associated with a shrink event and the corresponding shrink event data such that only certain transactions are labeled within the input data.

At 220, the shrink store context predictor trains an MLM 116 on features derived from the input data and known shrink events identified in the security data to produce shrink scores as output for the features and for combinations of the features. In an embodiment of 220 and 212, at 221, the shrink store context predictor provides the labeled shrink event data as expected predicted output from the MLM 116 for the features provided as input.

In an embodiment of 221 and at 222, the shrink store context predictor obtains weather data associated with a date of each transaction for a geographical location of the store. This is obtained through a weather-based web service using a known address or zip code for the store to obtain historical weather data for the store on the date and time of day associated with the corresponding transaction. The weather data is labeled as being sunny, cloudy, windy, rainy, snowy and the temperature is compared to a predefined temperature to indicate whether it was cold, hot, warm, or comfortable. The labeled weather data for the corresponding transaction is inserted into the input data as a weather feature known for the store on the transaction date of the corresponding transaction.

In an embodiment of 222 and at 223, the shrink store context predictor identifies any risk score provided in the security data for the transaction, a customer, a terminal, and a cashier. This risk score is associated with store-based MLMs or heuristic algorithms that assigned a risk of fraud or theft for the transaction when it was originally processed at the store. These risk scores are labeled and retained as additional features within the input data for the training session with the MLM 116.

In an embodiment of 223 and at 224, the shrink store context predictor generates second features for calendar dates, basket items, checkout channel, identify of the cashier, identify of the customer, and payment method per transaction. For example, the calendar date is labeled for being a weekday, a weekend, or a known holiday. The item codes associated with the basket of items for the transaction are labeled and retained in the input data. The checkout channel is identified as being online, in-store at a POS terminal, or in-store at an SST. The payment method is identified as being cash, credit card, give card, check, debit card, etc.

At 230, the shrink store context predictor obtains real-time transaction data and security date from the store as current input data. The transaction data is obtained in real time from transaction system 123 and the security data is obtained in real time from security system 124.

At 240, the shrink store context predictor extracts current features from the current input data. Any features that require being added to the current input data is obtained and added, such as weather data as discussed above with embodiment 222.

At 250, the shrink store context predictor provides the current features as input to the MLM 116. At 260, the shrink store context predictor receives current scores as output from the MLM 116. The scores corresponding to a percentage value that a given feature or a given combination of features is likely or not likely to be associated with shrink at the store.

At 270, the shrink store context predictor generates a data structure depicting a physical layout of the store with the features uniquely visually identified based on their corresponding current scores. Icons, labels, or images of the features are overlaid on the physical layout to provide an augmented visualization the physical areas of the store.

In an embodiment, at 271, the shrink store context predictor generates the data structure as a heatmap with a timeline function. The timeline function permits the heatmap to be animated from a current time to a designated future time. This permits a store manager to visualize shirk risk for a given business day for each hour the store is opened for business and plan accordingly as to where focus should be placed to mitigate shrink risk during business hours.

At 280, the shrink store context predictor renders the data structure within an interactive interface to a store user. For example, the data structure is rendered as a heatmap within heatmap interface 118.

In an embodiment, at 290, the shrink store context predictor iterates to 230 at preconfigured intervals of time to obtain updated real-time transaction data. This permits the data structure to be updated throughout the business hours of the store during a business day as conditions change within the store.

In an embodiment, at 295, the shrink store context predictor sends feature identifiers for the features and the corresponding current scores to a system or an application of the store using an API. For example, the current scores can be consumed and processed further by in-store software resources by integrating API 119 into workflows and applications associated with system 123 and/or system 124. The applications can provide additional capabilities based on the current scores to direct the attention of the store manager to resources and areas of the store that are likely to experience shrink for mitigating actions such as increased security or cashier training, etc.

FIG. 3 is a flow diagram of another method 300 for providing real-time risk assessments of shrink, according to an example embodiment. The software module(s) that implements the method 300 is referred to as a “shrink heatmap manager.” The shrink heatmap manager is implemented as executable instructions programmed and residing within memory and/or a non-transitory computer-readable (processor-readable) storage medium and executed by one or more processors of one or more devices. The processor(s) of the device(s) that executes the shrink heatmap manager are specifically configured and programmed to process the shrink heatmap manager. The shrink heatmap manager has access to one or more network connections during its processing. The network connections can be wired, wireless, or a combination of wired and wireless.

In an embodiment, the device that executes the shrink heatmap manager is cloud 110. In an embodiment, the device that executes the shrink heatmap manager is server 110. In an embodiment, the device that executes the shrink heatmap manager is retail server 120. In an embodiment, the shrink heatmap manager is provided to a retail server 120 and/or a user-operated device as a SaaS integrated into applications executing on the server 120 and/or user-operated device via APIs or API calls.

In an embodiment, the shrink heatmap manager is all of, or some combination of 113, 114, 115, 116, 117, 118, 119, and/or method 200. The shrink heatmap manager presents another and, in some ways, enhanced processing perspective from that which was discussed above with the method 200 of the FIG. 2.

At 310, the shrink heatmap manager derives features indicative of shrink from store data that is obtained from store systems 123 and/or 124 of a store. Features can be added, assigned a classification, and/or uniquely identified within the store data.

In an embodiment, at 311, the shrink heatmap manager retains predictive values as first features from the input data. The predictive values are present in the store data and were provided by other MLMs associated with the store systems 123 and/or 124 within the store data.

In an embodiment of 311 and at 312, the shrink heatmap manager obtains external data as second features. The external data is associated with dates of transactions and a physical or geographical location of the store; for example, weather data for the store on the date of any given transaction.

In an embodiment of 312 and at 313, the shrink heatmap manager identifies third features as transaction and terminal types for the transactions. The transaction types can include in-store, online, purchase transaction, refund transaction, etc. The terminal types can include an SST or a POS terminal.

In an embodiment of 313 and at 314, the shrink heatmap manager identifies additional features associated with identifies of the cashiers and the customers and associated with payment methods of the transactions. For example, customers associated with being loyalty members are uniquely identified, cashier identifiers for cashiers are uniquely identified, and the payment methods of cash or card is identified for each transaction.

At 320, the shrink heatmap manager provides the features as input to an MLM 116. The training of the MLM 116 was discussed above with FIG. 1 and method 200 of FIG. 2.

At 330, the shrink heatmap manager receives as output from the MLM 116 scores that predict whether shrink is likely to occur or no likely to occur for each of the features and for combinations of the features within a given interval of future time. Each score is a percentage from 0 to 100, each score is associated with a specific feature or associated with a combination of features.

At 340, the shrink heatmap manager generates a heatmap depicting resources within a physical layout of the store. The planogram 126 provides a visualization of the store and some of its physical resources such as aisles, shelves, displays, departments, entry and exit points, terminals, items on displays and/or shelves, etc.

At 350, the shrink heatmap assigns color and gradations of color to each of the resources based on a corresponding score assigned to the corresponding feature, which is associated with a given resource. Each unique color or gradation in color maps to a given score. For example, dark green is a score of 0 or no risk of shrink, dark red is a score of 1 or 100 with high risk of shrink, dark blue is a score of 0.5 or 50 with a medium risk of shrink; color gradations between dark green to dark blue and between dark blue to dark red associated with a scale of scores above 0 but below 1 or 100.

At 360, the shrink heatmap manager provides a callable function associated with the heatmap that permits the heatmap to be animated from the current time to an end of the future time. The animation visually depicts risk associated with shrink within the context of the store's physical layout through changing colors associated with the resources over time.

At 370, the shrink heatmap manager renders the heatmap within an interface 118. A store user, such as a store manager, operates a user device to interact with the heatmap via the interface 118.

In an embodiment, at 380, the shrink heatmap manager iterates to 310 when the current time elapses by a preconfigured amount of time to update the scores and the heatmap based on updated store data received from the store systems 123 and 124. In an embodiment, at 390, the shrink heatmap manager provides feature identifiers for the features and the scores to applications associated with the store systems 123 and/or 124. In an embodiment, at 395, the shrink heatmap manager trains the MLM 116 based on actual shrink events identified in the store data. This permits the f1 score for MLM 116 to continuously improve over time.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
obtaining, as input, transaction data, customer data, employee data, and security data as input data for a store;
training a machine learning model (MLM) on features derived from the input data and known shrink events identified in the security data to produce, as output, shrink scores for the features and for combinations of the features;
obtaining real-time transaction data and security data from the store as current input data;
extracting current features from the current input data;
providing the current features as input to the MLM;
receiving current scores as output from the MLM;
generating a data structure depicting a physical layout of the store with the features uniquely visually identified based on their corresponding current scores and overlaid on the physical layout; and
rendering the data structure within an interface accessible by a store user.

2. The method of claim 1 further comprising, iterating to the obtaining of the real-time transaction data and the security data at preconfigured intervals of time.

3. The method of claim 1 further comprising, sending feature identifiers for the features and the corresponding current scores to a system or an application of the store using an application programming interface.

4. The method of claim 1, wherein obtaining the transaction data further includes merging and associating the input data by transaction.

5. The method of claim 4, wherein merging further includes labeling each transaction within the input data with any shrink event data associated with a shrink event for the corresponding transaction.

6. The method of claim 5, wherein training further includes providing the labeled shrink event data as expected predicted output produced by the machine learning model based on the features.

7. The method of claim 6, wherein training further includes obtaining weather data associated with a date of each transaction for a location of the store and generating a weather feature for the corresponding transaction based on the weather data.

8. The method of claim 7, wherein training further includes identifying at least one risk score provided in the security data for one or more of a corresponding transaction, a customer, a terminal, and a cashier, and generating at least one additional feature for the at least one risk score.

9. The method of claim 8, wherein training further includes generating second features for the transactions based on 1) calendar dates relative to weekdays, weekend, and known holidays, 2) basket items for the corresponding transaction, 3) checkout channel for the corresponding transaction, 4) a cashier identifier for the corresponding transaction, 5) a loyalty member of the store or a non-loyalty member associated with a customer for the corresponding transaction; and 6) a method of payment for the corresponding transaction.

10. The method of claim 1, wherein generating further includes generating the data structure as a heatmap with a timeline function that permits the heatmap to be animated from a current time to a future time.

11. A method, comprising:
deriving features indicative of shrink from store data that is obtained from store systems and from data stores of a store;
providing the features as input to a machine-learning model (MLM);
receiving as output from the MLM scores that predict whether shrink is likely to occur or not for each of the features and for combinations of the features within a given interval of future time beginning with a current time;
generating a heatmap depicting resources associated with the features and resource locations for the resources within a physical layout of the store;
assigning indicia to each of the resources based on a corresponding score assigned to the corresponding feature;
providing a function associated with the heatmap, wherein the function when accessed from the heatmap performs operations comprising:
animating from the current time to an end of the given interval of future time; and
visually depicting risk associated with shrink within the context of the physical layout of the store through changing colors associated with the resources over time based on the animating; and
rendering the heatmap with the function within an interactive interface to a store user.

12. The method of claim 11 further comprising, iterating to the deriving when the current time elapses by a preconfigured amount of time to update the scores and the heatmap based on updated store data for the store.

13. The method of claim 11 further comprising, providing feature identifiers for the features and the scores to applications associated with the store systems.

14. The method of claim 13 further comprising, training the MLM based on actual shrink events identified in the store data.

15. The method of claim 11, wherein deriving further include retaining predictive values provided by other MLMs from the store systems within the store data as first features.

16. The method of claim 15, wherein deriving further includes obtaining external data associated with dates of transactions and a physical location of the store as second features.

17. The method of claim 15, wherein deriving further includes identifying third features as transaction and terminal types associated with the transactions.

18. The method of claim 17, wherein deriving further includes identifying additional features associated with identities of cashiers for the transactions, identities of customers for the transactions, and payment methods used in the transactions.

19. A system, comprising:
a cloud server comprising at least one processor and a non-transitory computer-readable storage medium,
the non-transitory computer-readable storage medium comprising executable instructions,
wherein the executable instructions, when executed by the at least one processor cause the at least one processor to perform operations comprising:
training a machine learning model (MLM) on features derived from store data obtained from store systems and data stores of a store to produce as output a time series of sets of scores over a predefined period of time that predicts at each interval a corresponding set of scores indicating how likely each feature or combinations of the features is likely or not likely to be associated with shrink during the corresponding interval;
receiving real-time store data at a current interval of time from the store systems and the data stores;
deriving current features from the real-time store data;
providing the current features as input to the MLM;
receiving as output current sets of current scores for current features and current combinations of the features, wherein a last set of the current scores ends at a close of business hours for the store;
obtaining a planogram for a physical layout of the store with resource identifiers for resources of the store identified within the physical layout;
generating a heatmap data structure with labels or images for the resource identifiers superimposed on top of the physical layout;
assigning indicia to certain resources and certain combinations of the resources that are associated with the current features and the current combinations based on the corresponding current scores;
providing a function with the heatmap data structure to animate the certain resources, the certain combinations, and the corresponding indicia within the physical layout over time until the close of the business hours for the store; and
rendering the heatmap data structure within an interactive interface on a device operated by a store user for the user to visually identify areas within the store, the certain resources, and combinations of the certain resources that are associated with high risk of shrink throughout the business hours of the store.

20. The system of claim 19, wherein the executable instructions when executed by the at least one processor further cause the processor to perform additional operations, comprising:
providing feature identifiers for the current features and the corresponding scores for the current features and the current combinations of features to one or more workflows processed by the store systems through an application programming interface.
